(19) United States
(12) Patent Application Publication
(10) Pub. No.: US 2002/0145584 A1
(43) Pub. Date: Oct. 10, 2002

(54) Liquid crystal display column capacitance charging with a current source

(76) Inventor: John Karl Waterman, Mesa, AZ (US)

Correspondence Address: PAUL N. KATZ, BAKER BOTTS L.L.P., ONE SHELL PLAZA, 901 LOUISIANA STREET, HOUSTON, TX, 77002-4995, US

(21) Appl. No.: 09/827,558

(22) Filed: Apr. 6, 2001

(51) Int. Cl. G09G 3/36

(52) U.S. Cl. 345/98

(57) ABSTRACT

A liquid crystal display (LCD) charges column capacitance with quantized charge injection from a current source. A digital-to-analog converter (DAC) injects amplitude and/or time duration controlled current pulses, using a current mirror, to charge each column capacitance to a desired voltage charge. The rate of charge is linear and fast, and no power is wasted as would be from quiescent current required in a voltage charging device used in a voltage injection column capacitance configuration. Variations in column capacitance may be compensated for by adding capacitance thereto or adjusting the amplitude and/or the pulse-width time of a current pulse being injected into the column capacitance.

### FIELD OF THE INVENTION

The present invention relates generally to liquid crystal display devices, and more particularly to a system and method using a current source for charging each of the liquid crystal display columns to a desired voltage.

### BACKGROUND OF THE INVENTION TECHNOLOGY

Liquid crystal displays (LCDS) are commonly used in devices such as portable televisions, portable computers, control displays, and cellular phones to display information to a user. LCDs act in effect as a light valve, i.e., they allow transmission of light in one state, block the transmission of light in a second state, and some include several intermediate stages for partial transmission. When used as a high resolution information display, as in one application of the present invention, LCDs are typically arranged in a matrix configuration with independently controlled display areas called “pixels” (the smallest segment of the display). Each individual pixel is adapted to selectively transmit or block light from a backlight (transmission mode), from a reflector (reflective mode), or from a combination of the two (transflective mode).

A LCD pixel can control the transference for different wavelengths of light. For example, an LCD can have pixels that control the amount of transmission of red, green, and blue light independently. In some LCDs, voltages are applied to different portions of a pixel to control light passing through several portions of dyed glass. In other LCDs, different colors are projected onto the area of the pixel sequentially in time. If the voltage is also changed sequentially in time, different intensities of different colors of light result. By quickly changing the wavelength of light to which the pixel is exposed an observer will see the combination of colors rather than sequential discrete colors. Several monochrome LCDs can also result in a color display. For example, a monochrome red LCD can project its image onto a screen. If a monochrome green and monochrome blue LCD are projected in alignment with the red, the combination will be a full range of colors.

The monochrome resolution of an LCD can be defined by the number of different levels of light transmission or reflection that each pixel can perform in response to a control signal. A second level is different from a first level when a user can tell the visual difference between the two. An LCD with greater monochrome resolution will look clearer to the user.

LCDs are actuated pixel-by-pixel, either one at a time or a plurality simultaneously. A voltage is applied to each pixel area by charging a capacitor formed in the pixel area. The liquid crystal responds to the charged voltage of the pixel capacitance by twisting and thereby transmitting a corresponding amount of light. In some LCDs an increase in the actuation voltage decreases transmission, while in others it increases transmission. When multiple colors are involved for each pixel, multiple voltages are applied to the pixel at different positions (different capacitance areas being charged of a pixel) or times depending upon the LCD illumination method. Each voltage controls the transmission of a particular color. For example, one pixel can be actuated to allow only blue light to be transmitted while another allows only green. A greater number of different light levels available for each color results in a much greater number of possible color combinations.

Converting a complex digital signal that represents an image or video into voltages to be applied to charge the capacitance of each pixel of an LCD involves circuitry that can limit the monochrome resolution. The signals necessary to drive a single color of an LCD are both digital and analog. It is digital in that each pixel requires a separate selection signal, but it is analog in that an actual voltage is applied to charge the capacitance of the pixel in order to determine light transmission thereof

Each pixel in the array of the LCD is addressed by both a column (vertical) driver and a row (horizontal) driver. The column driver turns on an analog switch that connects an analog voltage representative of the video input (control voltage necessary for the desired liquid crystal twist) to the column, and the row driver turns on a second analog switch that connects the column to the desired pixel.

The video inputs to the LCD are analog signals centered around a center reference voltage of typically from about 7.5 to 8.0 volts. A voltage called “VCOM” is not a supply voltage or signal from anywhere, but typically is a few hundred millivolts below the center reference voltage. VCOM is adjusted for best image quality, e.g., minimum flicker and/or image sticking. The center reference voltage connects to the LCD cover glass electrode which is a transparent conductive coating on the inside face (liquid crystal side) of the cover glass. This transparent conductive coating is typically Indium Tin Oxide (ITO).

One frame of video pixels are run at voltages above the center reference voltage (positive inversion) and for the next frame the video pixels are run at voltages below the center reference voltage (negative inversion). Alternating between positive and negative inversions results in substantially a zero net DC bias at each pixel. This substantially reduces the “image sticking” phenomena.

Writing video voltage values to each pixel in, for example, an 800×600 (SVGA) frame takes about 2 milliseconds using 8 analog channels (DACs) in parallel operation, with each analog channel given about 25 nanoseconds to apply the appropriate video voltage value to each of its set of pixels of the SVGA frame. Unfortunately, the liquid crystal material itself takes about 3 to 4 milliseconds to settle to within one percent of its final reflectivity. That leaves very little time to flash the light source (for example: light emitting diodes—LED) for the illumination step. For example, using a three color frame image at 80 Hz, each of the color (red-green-blue) frames at 240 Hz, allows only 4.2 milliseconds per frame. Considering the requirements imposed by frame inversion, and the problem of color-breakup with color-sequential images, 80 Hz is about the slowest rate at which to present images.

Writing voltage values to columns of the LCD requires a voltage source(s) capable of rapidly charging a capacitor. The final voltage value on a column is approached exponentially in time, this time is typically from about 5 to 30 nanoseconds. The voltage source amplifier(s) used to charge the column capacitance require a large quiescent operating current in order to achieve the 5 to 30 nsec. charge time. The amount of current eventually diverted over to the LCD pixel capacitance during voltage charging thereof is infinitesimal compared to the voltage source amplifier quiescent operating current. Thus a significant amount of power is wasted in the LCD driver electronics which reduces the feasibility of using an LCD in applications requiring very low power.

What is needed is an LCD and driver that uses a minimum amount of power in its operation.

### SUMMARY OF THE INVENTION

The present invention overcomes the above-identified problems as well as other shortcomings and deficiencies of existing technologies by providing a system and method for quickly and accurately writing video frame information to a matrix of pixels of a liquid crystal display (LCD) using a minimum amount of power. In accordance with exemplary embodiments of the present invention, the capacitance of each column is charged to a desired voltage by using a current source. The voltage being charged onto the column capacitance increases linearly with the current being sent thereto and is very fast (linear, not exponential). The LCD wastes no power for quiescent current (no voltage source needed). The LCD of the present invention may have its matrix of pixels and associated support electronics, e.g., row and column selection switches and drivers, analog switches, and the like fabricated onto a semiconductor integrated circuit die, e.g., a microdisplay. The electronics controller may be fabricated on one or more semiconductor integrated circuit dice and connected to the LCD electronics.

In an exemplary embodiment, the capacitance of each column of a liquid crystal display (LCD) is charged with quantized (magnitude and time) current charges injected from a current source(s). Before charging each column capacitance, the column capacitance may be set to a known charge (precharge), e.g., a predefined voltage or no charge at all, i.e., no voltage difference between the column capacitor and the ITO layer. No charge on each of the column capacitors may be obtained by electrically connecting the columns to the ITO layer, individually or at the same time. Setting the columns to a known charge may be accomplished by connecting each of the column capacitors to a known charge or voltage source, or by connecting all of the columns together and then measuring the resulting voltage charge on any of the columns. The rows may be individually or simultaneously connected to the columns during this precharge operation so that all of the pixel capacitors are precharged to a known voltage value (either a voltage or no voltage).

A digital-to-analog converter (DAC) may be used to inject time duration controlled current pulses, using for example, but not limited to, a current mirror to charge each column capacitance to a desired voltage charge. The rate of charging is linear and fast, and has no power wastage from quiescent current in a voltage charging device as would be needed in a voltage injection column capacitance configuration. Variations in column capacitance may be compensated for by adding capacitance so as to achieve matching column capacitance or adjusting the value of current pulses being injected and/or the time duration of the current pulses for each of the columns depending upon their capacitance.

Preferably, the capacitance of each column may be closely matched during the design and fabrication of the LCD structure. Properly designed layout and construction may render columns having substantially the same capacitance.

Another exemplary embodiment may include trimming capacitors for each of the columns so that during fabrication the capacitance of each column could be adjusted to the same average value. Fusible links may connect a plurality of capacitors for each column. These fusible links may be selectively blown to connected a desired amount of capacitance to each column so that each column has substantially the same capacitance value. The capacitors may be arranged in series-parallel combinations so that capacitance may be easily adjusted (by blowing the appropriate fuse links) for a desired total capacitance connected to each column.

Still another exemplary embodiment may use switchably controlled capacitors that may be connected to each of the columns when these columns are being charged by the current source pulses. The combination of switchably controlled capacitors required for each column may be stored in a programmable memory such as EPROM or EEPROM, and may be determined and programmed during manufacture and testing of the LCD. When the column is selected for charging, the appropriate number of capacitors are selected through this memory.

In yet another exemplary embodiment, the voltage value on the column capacitance resulting for a given pulse amplitude and time duration period may be measured, then a correction factor may be stored in a memory and thereafter applied to modify the current pulse(s) so as to compensate for the variations of each column capacitance.

In still another exemplary embodiment, the pixels along each column may be observed and the characteristics (amplitude and pulse duration) of the current pulses adjusted for each of the columns so that substantially the same light modification characteristics are observed for each column of pixels. The characteristics so determined may then be stored in a memory for use in the normal operation of the LCD. The current pulse characteristics for each of the columns may be stored in a lookup table (LUT) such as, for example but not limited to, the gamma LUT which then may select the appropriate pulse amplitude and time duration for each of the desired gray scale shades of the LCD. Pulse repetition rate may also be used in charging the column capacitance to a desired voltage value.

A technical advantage of the present invention is in the reduction of the power required for writing frames of a liquid crystal display. Another technical advantage is improved speed in writing a frame which reduces flicker and color-breakup artifacts. Another technical advantage is smaller and faster operating current mode digital-to-analog converters that may be imbedded into a semiconductor integrated circuit die. Still another technical advantage is obtaining a desired column voltage by controlling the pulse amplitude and/or pulse width time duration. Pulse repetition time rate may also be effectively utilized to charge the column capacitance to a desired voltage value.

Other technical advantages of the present disclosure will be readily apparent to one skilled in the art from the following figures, descriptions, and claims. Various embodiments of the invention obtain only a subset of the advantages set forth. No one advantage is critical to the invention.

### BRIEF DESCRIPTION OF THE DRAWINGS

A more complete understanding of the present disclosure and advantages thereof may be acquired by referring to the following description taken in conjunction with the accompanying drawings, wherein:

FIG. 1 is a schematic block diagram of an exemplary liquid crystal display system in accordance with exemplary embodiments of the present invention;

FIG. 2 is a schematic block diagram of a portion of the liquid crystal display of FIG. 1;

FIG. 3 is a schematic block diagram of an exemplary embodiment of the invention;

FIG. 4 is a schematic block diagram of another exemplary embodiment of the invention;

FIGS. 5 and 5A are schematic block diagrams of other exemplary embodiments of the invention having column voltage charge feedback sensing;

FIGS. 6 and 6A are schematic block diagrams of still other exemplary embodiment of the invention having automatic capacitance compensation; and

FIG. 7 is a schematic block diagram of another exemplary embodiment having programmable fuse links for connecting compensation capacitors to each column.

While the present invention is susceptible to various modifications and alternative forms, specific exemplary embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

The present invention is directed to a liquid crystal display device comprising a matrix of liquid crystal pixels having light modifying properties controlled by voltage values stored in a capacitor at each of the pixel locations. A plurality of digital-to-analog converters (DACs) are coupled to the pixel matrix and are adapted to produce current pulses that are applied to columns of the pixel matrix through analog switches. The current pulses charge each column capacitance to a desired voltage value. Row analog switches connect each column to a desired respective pixel on a selected row, thereby transferring the voltage values on the columns to the respective pixel capacitors. Voltage values on the columns may be determined by the amplitudes and/or the pulse-width times of the current pulses being injected into the columns. One or more current pulses may be used to charge each column to the desired voltage value.

Referring now to the drawings, the details of preferred embodiments of the invention are schematically illustrated. Like elements in the drawings will be represented by like numbers, and similar elements will be represented by like numbers with a different lower case letter suffix.

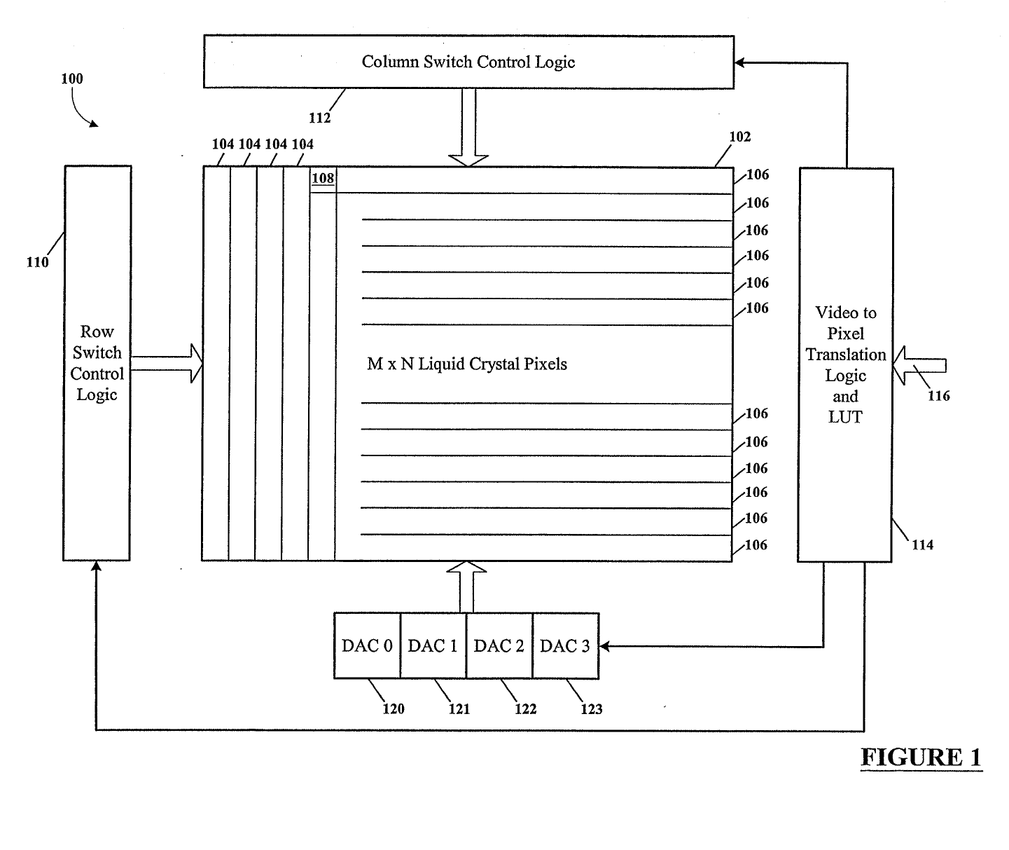

FIG. 1 illustrates a schematic block diagram of a liquid crystal display system in accordance with exemplary embodiments of the present invention. A high-level block diagram of a system for writing voltage values to pixels of a liquid crystal display (LCD) is generally represented by the numeral 100. The voltage values being written to the pixels are representative of a frame of video data. The voltage values control the “twist” of the liquid crystal material at each pixel area so that when a light is flashed on or through the LCD, the light polarization and ultimately the intensity of the light is controlled by the “twist” of the liquid crystal material at each pixel area of the LCD.

For illustrative and exemplary purposes, the LCD 100 depicted in FIG. 1 comprises a pixel matrix 102 of M rows 106 by N columns 104 for a total of M×N individually addressable pixels 108. The combination of row control logic 110 and column control logic 112 are used to select each of the pixels 108 for writing thereto in the LCD 100, as more fully described herein. Video to pixel translation logic and a look-up table (LUT) (hereinafter translation logic) 114 perform the necessary calculations and steps to translate a video frame image 116 into discrete digital values which are sent to digital-to-analog converters (DACs) 120, 121, 122 and 123, and the pixel location addresses thereof are sent to the row and column control logic 110 and 112. It is contemplated and within the scope of the present invention that any number of DACs may be used according to exemplary embodiments of the present invention. The DACs 120, 121, 122 and 123 are current source DACs which have outputs comprising analog current values corresponding to digital input words from the translation logic 114.

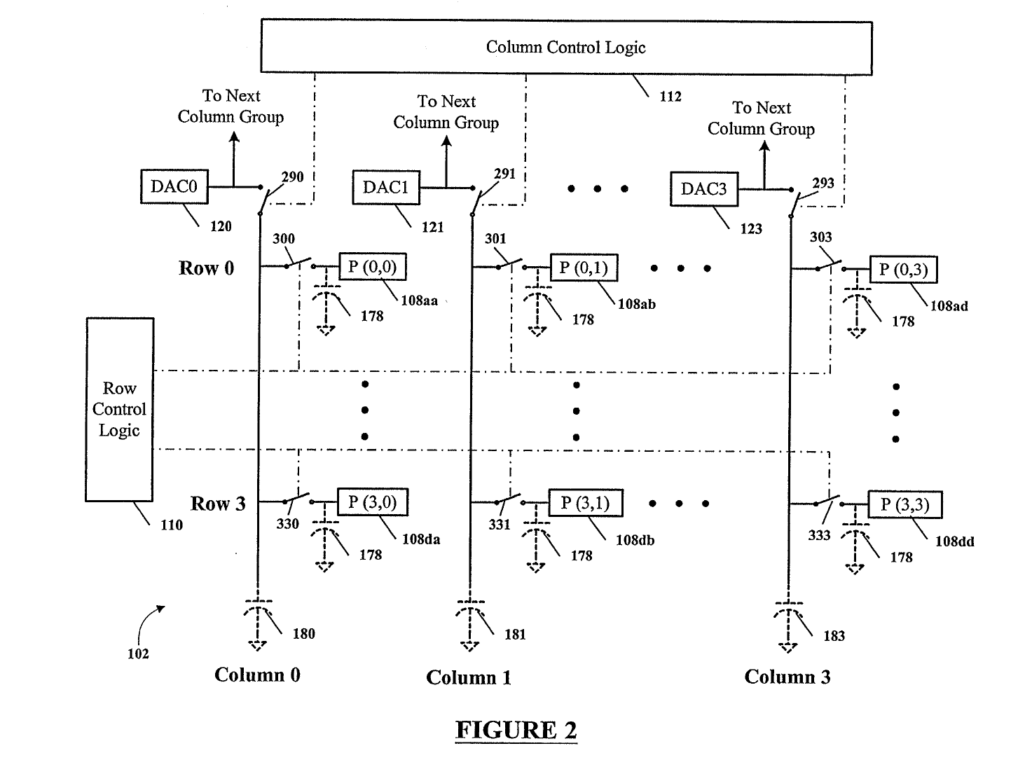

Referring now to FIG. 2, a schematic block diagram of a portion of the liquid crystal display system 100 of FIG. 1 is illustrated. A portion of the pixel matrix 102 is represented for illustrative and exemplary purposes as pixels 108aa-108dd (4×4 matrix), pixel row switches 300 through 333 and pixel column switches 290 through 293. An LCD operates by charging each pixel 108aa-108dd of the LCD 100 to desired voltage values. A voltage at a pixel 108 causes liquid crystals at that pixel area to change their “twist” orientation so that light passing through the LCD 100 or being reflected is thereby affected. The translation logic 114 uses the received video frame information 116 to create appropriate voltage values which are representative of that portion of the video frame at each one of the pixel locations. In addition, the translation logic 114 associates an x-y coordinate (row-column) location for each of these pixel voltage values.

The DACs 120-123 receive digital representations of current values from the translation logic 114 and convert these digital representations to analog current values which must then be applied to each corresponding column 104. Each column comprises a metal or other conductive material trace that is parallel with the ITO layer (transparent metal coating on the LCD front cover). The column traces are insulated from the ITO layer and the combination thereof forms the column capacitors 180, 181 and 183. Each of the pixels 108aa-108dd is formed by a “pixel mirror” which is electrically conductive and light reflective. Each of the pixel mirrors is parallel with the ITO layer and the combinations thereof form the pixel capacitors 178.

Each of the columns 0, 1 and 3 has a capacitance 180, 181 and 183, respectively, associated therewith. The capacitance 178 of each pixel may not all be the same, nor may the capacitance 180, 181 and 183 of each column be the same. However, a column capacitance, e.g., 180 is greater than a pixel capacitance, e.g., 178. In the exemplary embodiments, an analog current value charges a respective column capacitance to a desired voltage value (after the column capacitance has been precharged to a certain value, e.g., all columns present to the same charge voltage value or discharged to zero voltage value). The current pulse output of the DAC is connected to the column and thereby charges the column capacitance to a desired analog voltage, each pixel in a selected row is connected to a corresponding column (the row pixels may be connected to the respective columns either before or after the respective columns are charged). Therefore, the voltage on the pixel will be substantially the same as the voltage on the corresponding column.

For example, a column(s) is charged to a certain voltage while a pixel row is selected so that the intersection(s) thereof is the desired pixel to be charged. For example, columns 0-3 are charged from the DACs 120-123, respectively, when the column switches 290-293 are closed. Pixels 108aa-108dd are charged from the columns 0-3, respectively, when the row switches 300-303 are closed (row 0). A plurality of DACs may be used to simultaneously charge a like number of columns, then a like number of switches in a row may be used to charge a like number of pixels from the respective charged columns. The column control logic 112 and row control logic 110 control operation of the column switches 290-293 and row switches 300-333, respectively, for the group of pixels 108aa-108dd. Other pixel groups 108 are controlled in a similar fashion.

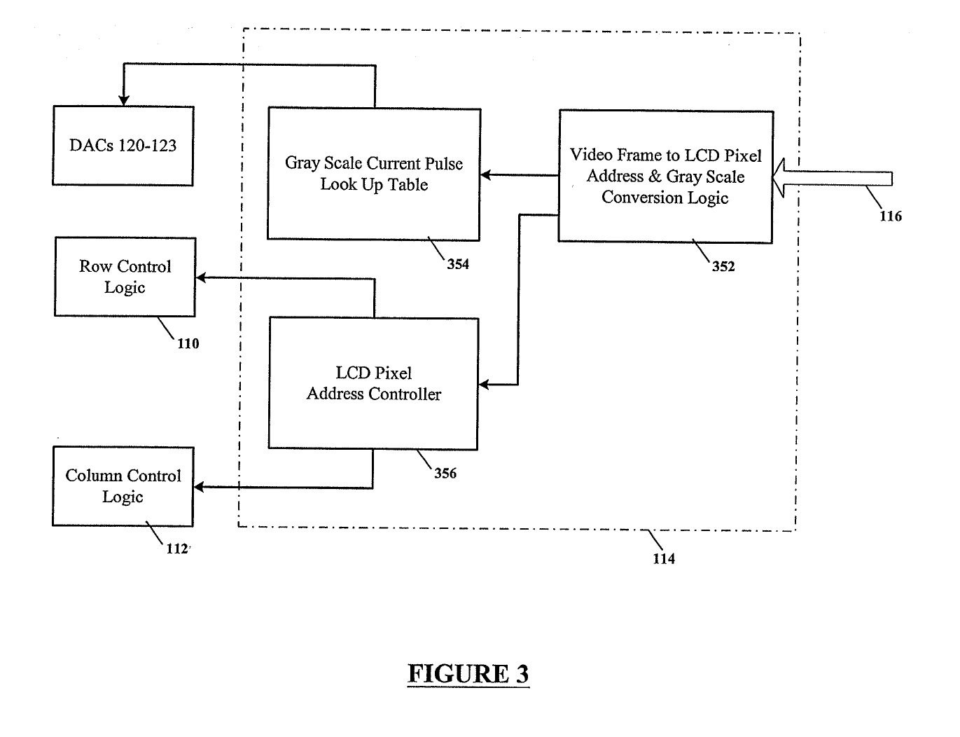

Referring now to FIG. 3, a schematic block diagram of an exemplary embodiment of the invention is illustrated. The current DACs 120-123 are adapted to receive digital current amplitude information from a gray scale current pulse look up table 354. The gray scale current pulse look up table 354 receives pixel grayscale information from the video frame to LCD pixel address and gray scale conversion logic 352 which is adapted to convert video information 116 into corresponding pixel information (grayscale and pixel address information). Pixel address information is sent to an LCD pixel address controller 356 which is adapted to control the row control logic 110 and column control logic 112. The gray scale current pulse look up table 354 determines the necessary current pulse amplitude and pulse-width time duration for charging the column capacitance to a desired voltage for transfer to the respective pixel. The voltage to which the column capacitance is charged is a function of the integral of the current pulse amplitude over a period of time divided by the capacitance of the column, and any initial voltage charge on the column capacitance. The energy stored in the column after being charged to the desired voltage is one-half the capacitance of the column times the voltage squared. For example, power consumption (energy times time) of an 800×600 pixel RGB LCD operating at 100 Hz and having an average column capacitance of one picofarad (1E-12) would be for a worse case black frame (V=13 volts):

0.5×1E-12×13×13×800×600×3×100=12 milliwatts

Therefore, each column capacitance may be charged to a desired voltage value by applying the correct current amplitude and width time pulse to the column. Generally since the pixel is already connected to its respective column, the column voltage is thereby transferred to the pixel capacitance.

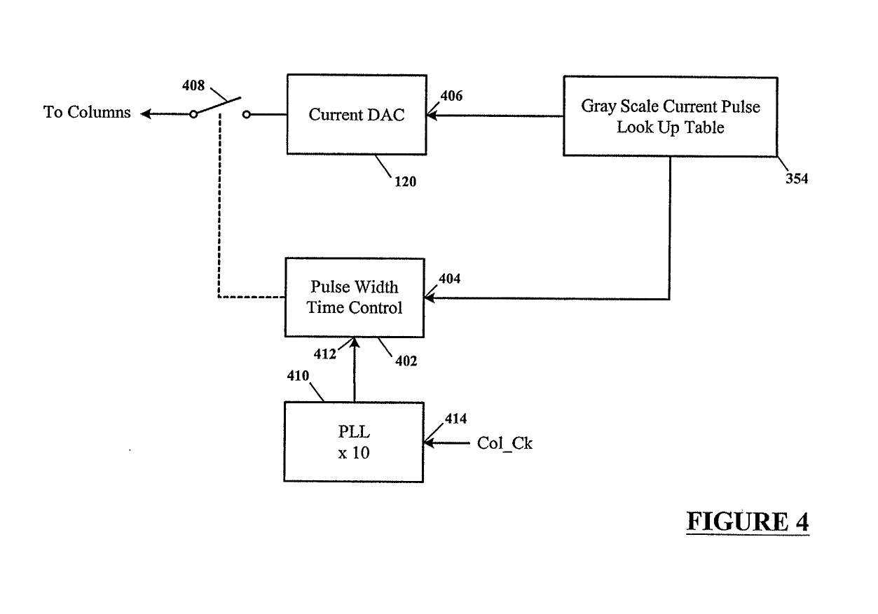

Referring now to FIG. 4, a schematic block diagram of another exemplary embodiment of the invention is illustrated. The gray scale current pulse look up table 354 may control the current pulse amplitude and/or pulse width time of the current DAC 120. For example, a binary digital value is applied at the input 406 of the DAC 120 which controls the amplitude value of the current from the output of the DAC 120 which is connected to switch 408. The binary digital value may be of any bit size, e.g., 10 bits is 1024 different current amplitude values. A switch 408 may be used to control the pulse width time of the output current from the DAC 120. The pulse width time may be selected from a frequency at a clock input 412. The clock input 412 may be from an output of a phase-locked-loop (PLL) 410. The PLL 410 may be used to multiply the frequency of the column clock and also to synchronize the pulse width time control 402 to the column clock. For example, a column clock (Col_Ck) frequency may be multiplied by ten so that there are ten different pulse width selections available using a four bit binary or BCD signal at input 404, or eight different pulse width selections using a three bit binary signal at input 404. For example, using an 10 bit amplitude word and a four bit pulse-width time word results in being able to programmably charge over 10,000 different voltage values on the column capacitance.

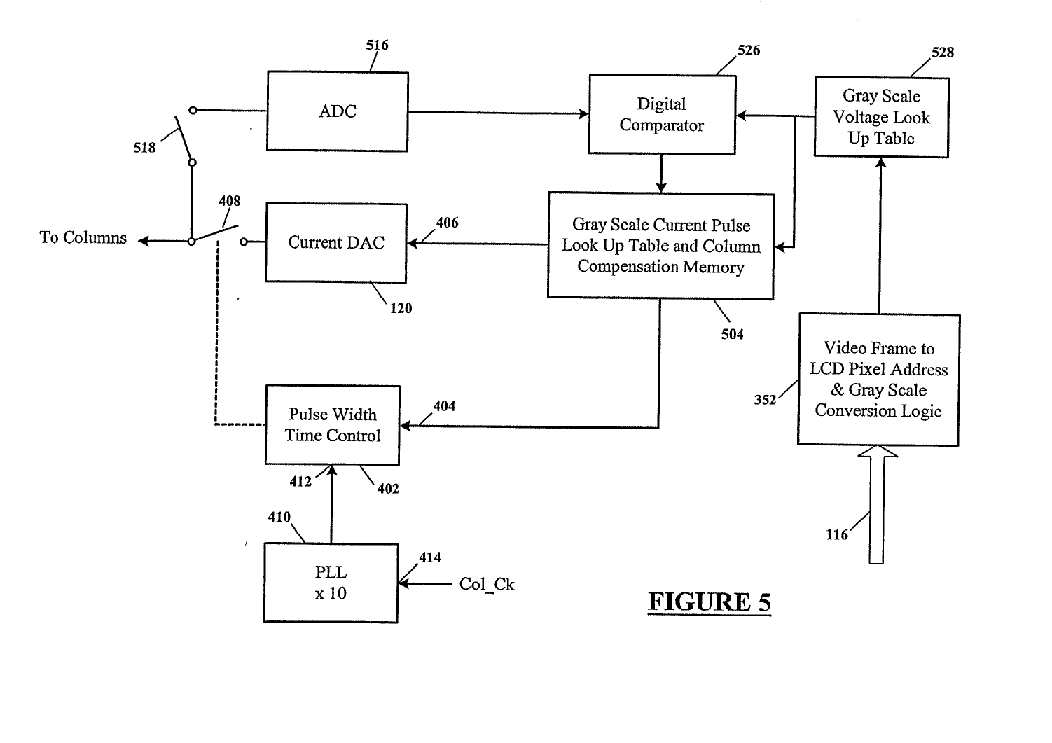

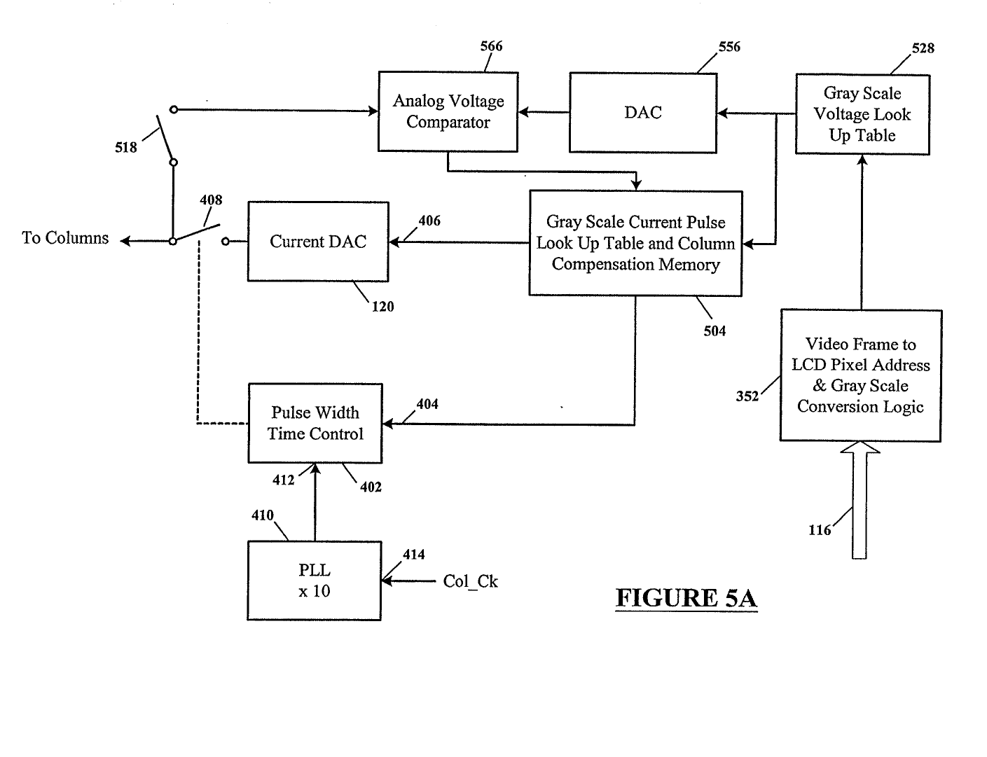

Referring now to FIG. 5, a schematic block diagram of another exemplary embodiment of the invention having column voltage charge feedback sensing is illustrated. Video information 116 is received by the video frame to LCD pixel address and gray scale conversion logic 352 and is converted into pixel information for display on the LCD matrix 102 (FIG. 1). The pixel information from the LCD pixel address and gray scale conversion logic 352 is applied to a gray scale voltage look-up table 528 which converts the pixel gray scale information into an equivalent gray scale digital voltage value required at the pixel so as to obtain the desired gray scale shade from the liquid crystal. This gray scale digital voltage value may be any number of bits in size, e.g., an 8 bit binary word.

A gray scale current pulse look-up table 504 converts the gray scale digital voltage value is into a digital current pulse value for controlling the amplitude value of a current pulse from the DAC 120. The gray scale current pulse look-up table 504 may also control the time duration (width) of the current pulse using the pulse width time control 402 and current output switch 408. The functional purpose of the switch 408 may be integral with the DAC 120, e.g., an internal disable or shut down circuit in the DAC 120. The current pulse width may be selected according to the granularity of a clock input 412, e.g., from a phase-locked-loop (PLL) 410 which may be synchronized to a column clock (Col_Ck) input 414. In the example illustrated in FIG. 5, a selection from 1 to 10 of the column clock is available when a 4 bit pulse-width time selection value is at the input 404 of the pulse width time control 402.

Column capacitance values may vary from one column to another, therefore current pulses having the same value will not charge to the same voltage columns having different capacitance values. This may be compensated for using this exemplary embodiment by measuring a resulting voltage on a column after a current pulse has voltage charged that column. A compensation coefficient may be determined for each column which may be factored with a general current pulse value e.g., amplitude and pulse-width (for all columns) to produce substantially the same voltage on each column even though each column may have a different capacitance. Switch 518 may be closed to connect the voltage charged column to an analog-to-digital converter (ADC) 516. The ADC 516 measures the column voltage by converting the analog voltage to a digital voltage value that may be input to digital comparator 526 or may be input directly to the gray scale current pulse look-up table 504 which also comprises a column compensation memory.

A comparison is made of the digital voltage value from the ADC 516 (representing the actual voltage on the column) and the desired gray scale voltage value for that column. If the comparison results in a difference between the desired and actual voltages on the column, a correction factor may be stored in the column compensation memory so that any variation from one column capacitance to another is thereby compensated for and the same gray scale current pulse value for a certain pixel voltage from the gray scale voltage look-up table 528 may be used regardless of any variations in the column capacitance. Column capacitance variation compensation may be performed upon start-up of the LCD system 100, during a test and calibrate mode, or performed during normal operation of the LCD system 100.

Referring now to FIG. 5A, a schematic block diagram of another exemplary embodiment of the invention having column voltage charge feedback sensing is illustrated. Video information 116 is received by the video frame to LCD pixel address and gray scale conversion logic 352 and is converted into pixel information for display on the LCD matrix 102 (FIG. 1). The pixel information from the LCD pixel address and gray scale conversion logic 352 is applied to a gray scale voltage look-up table 528 which converts the pixel gray scale information into an equivalent gray scale digital voltage value required at the pixel so as to obtain the desired gray scale shade from the liquid crystal. This gray scale digital voltage value may be any number of bits in size, e.g., an 8 bit binary word.

A gray scale current pulse look-up table 504 converts the gray scale digital voltage value is into a digital current pulse value for controlling the amplitude value of a current pulse from the DAC 120. The gray scale current pulse look-up table 504 may also control the time duration (width) of the current pulse using the pulse width time control 402 and current output switch 408. The functional purpose of the switch 408 may be integral with the DAC 120, e.g., an internal disable or shut down circuit in the DAC 120. The current pulse width may be selected according to the granularity of a clock input 412, e.g., from a phase-locked-loop (PLL) 410 which may be synchronized to a column clock (Col_Ck) input 414. In the example illustrated in FIG. 5, a selection from 1 to 10 of the column clock is available when a 4 bit pulse-width time selection value is at the input 404 of the pulse width time control 402.

Column capacitance values may vary from one column to another, therefore current pulses having the same value will not charge to the same voltage columns having different capacitance values. This may be compensated for using this exemplary embodiment by measuring a resulting voltage on a column after a current pulse has voltage charged that column. A compensation coefficient may be determined for each column which may be factored with a general current pulse value e.g., amplitude and pulse-width (for all columns) to produce substantially the same voltage on each column even though each column may have a different capacitance.

Switch 518 may be closed to connect the voltage charged column to an input of an analog voltage comparator 566. Another input of the comparator 566 is connected to a DAC 556. The DAC 556 generates an analog voltage from digital information from the gray scale voltage look-up table 528. The comparator 566 determines whether the voltage from switch 518 (representing the actual voltage on the column) is less than, equal to, or greater than the voltage from the DAC 556, the desired gray scale voltage value for that column. It is contemplated and within the scope of the present invention that the DAC 556 and comparator 566 functions may be combined into one mixed signal (analog and digital) comparator circuit having a single analog input, a digital reference value input, and a comparison output.

The results of the comparison from the comparator 566 is output to the gray scale current pulse look-up table 504. If the comparison results in a difference between the desired and actual voltages on the column, a correction factor may be stored in the column compensation memory 504 so that any variation from one column capacitance to another is thereby compensated for and the same gray scale current pulse value for a certain pixel voltage from the gray scale voltage look-up table 528 may be used regardless of any variations in the column capacitance. Column capacitance variation compensation may be performed upon start-up of the LCD system 100, during a test and calibrate mode, or performed during normal operation of the LCD system 100.

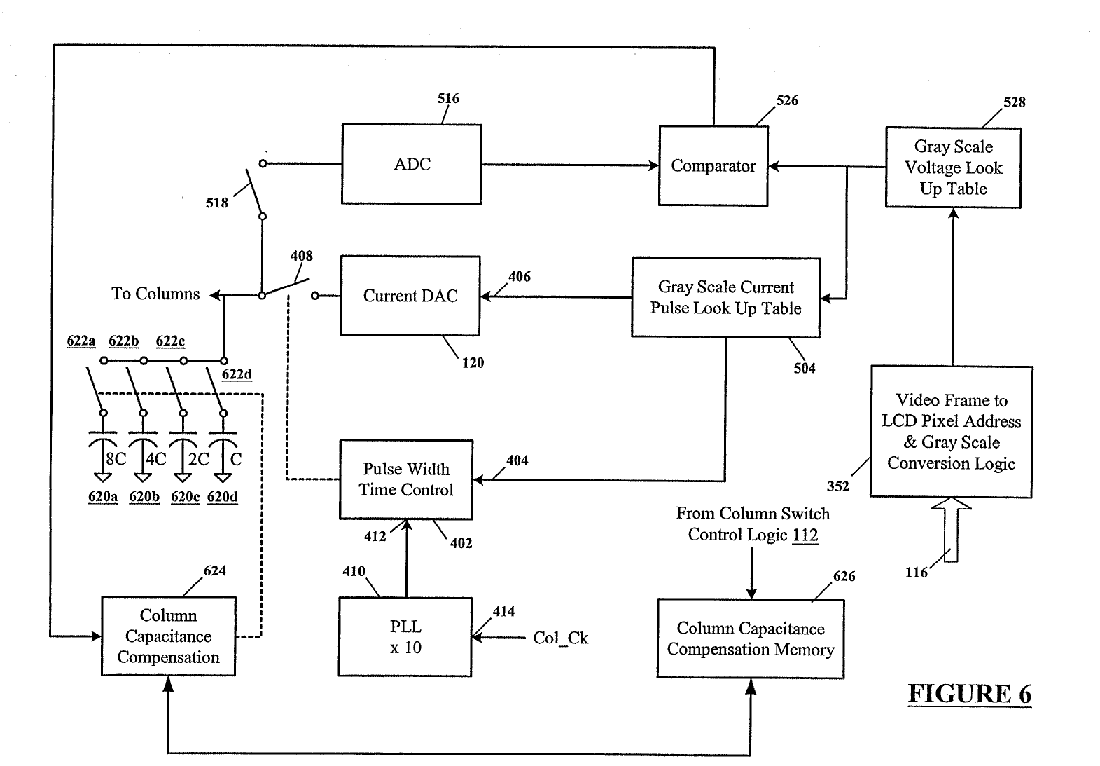

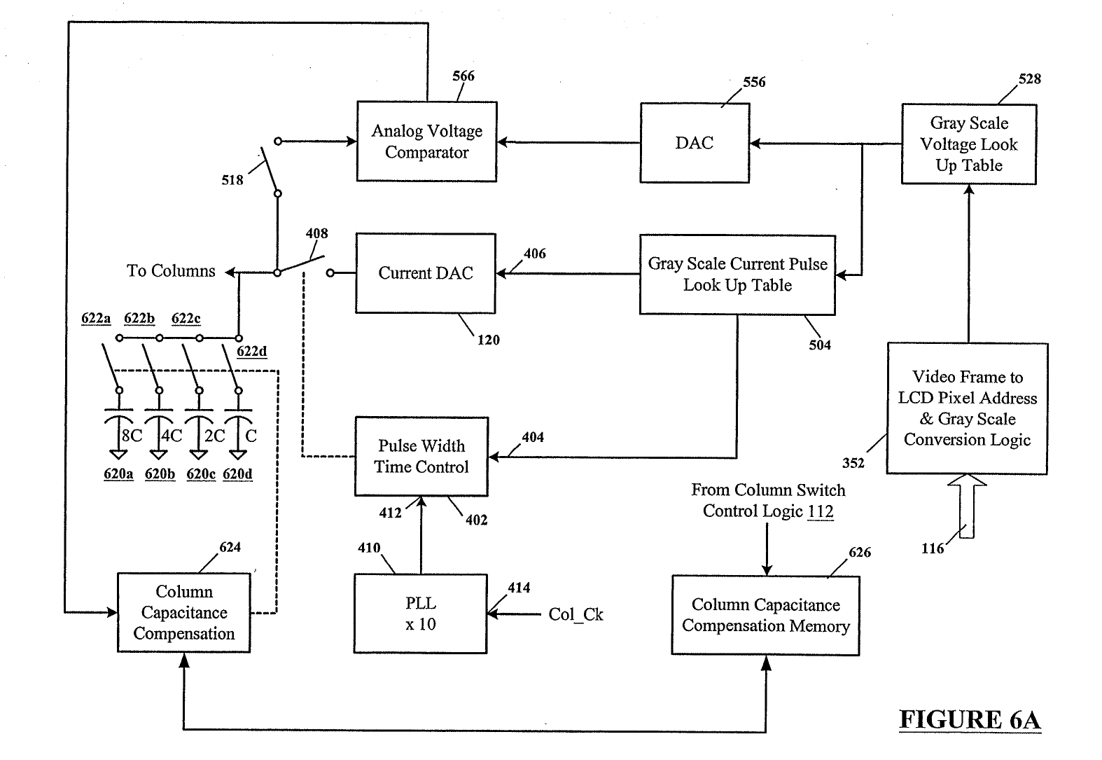

Referring now to FIG. 6, a schematic block diagram of another exemplary embodiment of the invention having automatic capacitance compensation is illustrated. Video information 116 is received by the video frame to LCD pixel address and gray scale conversion logic 352 and is converted into pixel information for display on the LCD matrix 102 (FIG. 1). The pixel information from the LCD pixel address and gray scale conversion logic 352 is applied to a gray scale voltage look-up table 528 which converts the pixel gray scale information into an equivalent gray scale digital voltage value required at the pixel so as to obtain the desired gray scale shade from the liquid crystal. This gray scale digital voltage value maybe any number of bits in size, e.g., an 8 bit binary word.

A gray scale current pulse look-up table 504 converts the gray scale digital voltage value is into a digital current pulse value for controlling the amplitude value of a current pulse from the DAC 120. The gray scale current pulse look-up table 504 may also control the time duration (width) of the current pulse using the pulse width time control 402 and current output switch 408. The functional purpose of the switch 408 may be integral with the DAC 120, e.g., an internal disable or shut down circuit in the DAC 120. The current pulse width may be selected according to the granularity of a clock input 412, e.g., from a phase-locked-loop (PLL) 410 which may be synchronized to a column clock (Col_Ck) input 414. In the example illustrated in FIG. 6, a selection from 1 to 10 of the column clock is available when a 4 bit pulse-width time selection value is at the input 404 of the pulse width time control 402.

Column capacitance values may vary from one column to another, therefore current pulses having the same value will not charge to the same voltage columns having different capacitance values. This may be compensated for using this exemplary embodiment by adding capacitance to a column to achieve an average value of capacitance for each column. Columns having a larger capacitance would require little or no added capacitance and columns having a smaller capacitance would require a greater amount of capacitance added thereto. Capacitors 620 are controllably connected to a column through switches 622 which are controlled by a column capacitance compensation circuit 624. The capacitors 620 may be arranged in a binary value order, e.g., capacitor 620a is 8C, capacitor 620b is 4C, capacitor 620c is 2C and capacitor 620d is C, where C is the capacitor value.

The required amount of capacitance to be added to each column may be determined by measuring a resulting voltage on a column after a current pulse has voltage charged that column. Switch 518 may be closed to connect the voltage charged column to an analog-to-digital converter (ADC) 516. The ADC 516 measures the column voltage by converting the analog voltage to a digital voltage value that may be input to comparator 526. A comparison is made of the digital voltage value from the ADC 516 (representing the actual voltage on the column) and the desired gray scale voltage value for that column. If the comparison results in a difference between the desired and actual voltages on the column, the column capacitance compensation 624 can increase or decrease the amount of capacitance of the column by switching an appropriate value of the capacitors 620. The required selection of the capacitors 620 may then be stored in a column compensation memory 626 so that any variation from one column capacitance to another is thereby compensated for and the same gray scale current pulse value for a certain pixel voltage from the gray scale voltage look-up table 528 may be used regardless of any variations in the column capacitance. For example, column selection information may be obtained from the column switch control logic 112. Column capacitance variation compensation may be performed upon start-up of the LCD system 100, during a test and calibrate mode, or performed during normal operation of the LCD system 100.

Referring now to FIG. 6A, a schematic block diagram of another exemplary embodiment of the invention having automatic capacitance compensation is illustrated. Video information 116 is received by the video frame to LCD pixel address and gray scale conversion logic 352 and is converted into pixel information for display on the LCD matrix 102 (FIG. 1). The pixel information from the LCD pixel address and gray scale conversion logic 352 is applied to a gray scale voltage look-up table 528 which converts the pixel gray scale information into an equivalent gray scale digital voltage value required at the pixel so as to obtain the desired gray scale shade from the liquid crystal. This gray scale digital voltage value may be any number of bits in size, e.g., an 8 bit binary word.

A gray scale current pulse look-up table 504 converts the gray scale digital voltage value is into a digital current pulse value for controlling the amplitude value of a current pulse from the DAC 120. The gray scale current pulse look-up table 504 may also control the time duration (width) of the current pulse using the pulse width time control 402 and current output switch 408. The functional purpose of the switch 408 may be integral with the DAC 120, e.g., an internal disable or shut down circuit in the DAC 120. The current pulse width may be selected according to the granularity of a clock input 412, e.g., from a phase-locked-loop (PLL) 410 which may be synchronized to a column clock (Col_Ck) input 414. In the example illustrated in FIG. 6, a selection from 1 to 10 of the column clock is available when a 4 bit pulse-width time selection value is at the input 404 of the pulse width time control 402.

Column capacitance values may vary from one column to another, therefore current pulses having the same value will not charge to the same voltage columns having different capacitance values. This may be compensated for using this exemplary embodiment by adding capacitance to a column to achieve an average value of capacitance for each column. Columns having a larger capacitance would require little or no added capacitance and columns having a smaller capacitance would require a greater amount of capacitance added thereto. Capacitors 620 are controllably connected to a column through switches 622 which are controlled by a column capacitance compensation circuit 624. The capacitors 620 may be arranged in a binary value order, e.g., capacitor 620a is 8C, capacitor 620b is 4C, capacitor 620c is 2C and capacitor 620d is C, where C is the capacitor value.

The required amount of capacitance to be added to each column may be determined by measuring a resulting voltage on a column after a current pulse has voltage charged that column. Switch 518 may be closed to connect the voltage charged column to an input of an analog voltage comparator 566. Another input of the comparator 566 is connected to a DAC 556. The DAC 556 generates an analog voltage from digital information from the gray scale voltage look-up table 528. The comparator 566 determines whether the voltage from switch 518 (representing the actual voltage on the column) is less than, equal to, or greater than the voltage from the DAC 556, the desired gray scale voltage value for that column. It is contemplated and within the scope of the present invention that the DAC 556 and comparator 566 functions may be combined into one mixed signal (analog and digital) comparator circuit having a single analog input, a digital reference value input, and a comparison output.

This determination is output from the comparator 566 to the column capacitance compensation circuit 624. If the desired voltage (from the gray scale voltage look-up table 528) and the actual voltage on the column (from switch 518 are not equal then the column capacitance compensation 624 can increase or decrease the amount of capacitance of the column by switching an appropriate value of the capacitors 620. The required selection of the capacitors 620 may then be stored in a column compensation memory 626 so that any variation from one column capacitance to another is thereby compensated for and the same gray scale current pulse value for a certain pixel voltage from the gray scale voltage look-up table 528 may be used regardless of any variations in the column capacitance. For example, column selection information may be obtained from the column switch control logic 112. Column capacitance variation compensation may be performed upon start-up of the LCD system 100, during a test and calibrate mode, or performed during normal operation of the LCD system 100.

The required selection of the capacitors 620 may determined during manufacture and/or final testing of the LCD. The desired selection of the capacitors 620 for each column 104 may be stored in an electrically programmable read only memory (EPROM) or electrically erasable and programmable read only memory (EEPROM) which may comprise the column capacitance memory 626.

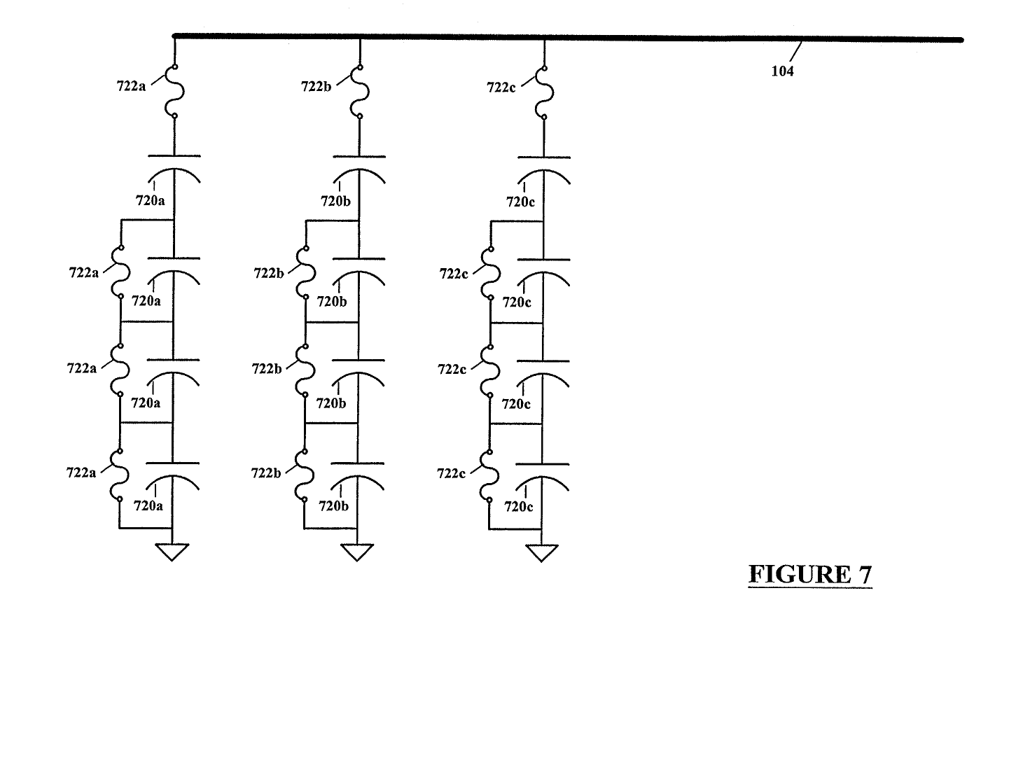

Referring to FIG. 7, depicted is a schematic block diagram of another exemplary embodiment having programmable fuse links for connecting compensation capacitors to each column. A column 104 may be connected to a plurality of capacitors 720 that are connected in a series-parallel combination. Fuse links 722 are further connected to the series-parallel combination of capacitors 720 and are adapted to be selectively blown during manufacturing and/or final testing of the LCD. Certain ones of the fuse links 722 are blown (open) so as to put in a parallel connected capacitor 720 or remove a series connected capacitor(s) 720 for compensating the column 104 capacitance. Each of the columns 104 may have a series-parallel connected compensation capacitor array so that during manufacture and/or final testing each of the columns 104 may be adjusted to have substantially the same capacitance. Three separate series connected capacitor strings are illustrated (720a, 720b and 720c) but one of ordinary skill in the art will readily understand, having the benefit of this disclosure, that any number and connection combination of capacitors 720 and fuse links 722 may be utilized for compensating the capacitance of each column 104.

It is contemplated and within the scope of the embodiments of the present invention that the LCD and LCD system may be partially or entirely fabricated on a semiconductor integrated circuit.

The invention, therefore, is well adapted to carry out the objects and attain the ends and advantages mentioned, as well as others inherent therein. While the invention has been depicted, described, and is defined by reference to exemplary embodiments of the invention, such references do not imply a limitation on the invention, and no such limitation is to be inferred. The invention is capable of considerable modification, alternation, and equivalents in form and function, as will occur to those ordinarily skilled in the pertinent arts and having the benefit of this disclosure. The depicted and described embodiments of the invention are exemplary only, and are not exhaustive of the scope of the invention. Consequently, the invention is intended to be limited only by the spirit and scope of the appended claims, giving full cognizance to equivalents in all respects.

What is claimed is:

1. A system using a current controlled charging circuit for charging columns of a liquid crystal display, said system comprising:
a liquid crystal display (LCD) having a matrix of liquid crystal pixels, said matrix comprising a plurality of columns and a plurality of rows, wherein an intersection of a row and a column defines a location of a pixel; and
at least one digital-to-analog converter (DAC) adapted to receive digital inputs representative of pixel gray scales, said at least one DAC having an output adapted for charging each of said plurality of columns to voltages representing said pixel gray scales, wherein the output comprises current source pulses having amplitudes and pulse-widths that charge each of said plurality of columns to said voltages.

2. The system of claim 1, wherein a plurality of row switches selectively couples said matrix of pixels to said plurality of columns.

3. The system of claim 2, wherein a plurality of column switches selectively couples the output of said at least one DAC to each of said plurality of columns.

4. The system of claim 3, wherein column control logic controls said plurality of column switches and row control logic controls said plurality of row switches.

5. The system of claim 4, further comprising an LCD pixel matrix address controller adapted for controlling said column and row control logic.

6. The system of claim 5, further comprising a video frame to LCD pixel matrix address logic coupled to said LCD pixel matrix address controller, said video frame to LCD pixel matrix address logic adapted to receive video information and generate LCD pixel matrix addresses for said LCD pixel matrix address controller.

7. The system of claim 1, further comprising a gray scale current pulse look-up table adapted for converting said pixel gray scales into the digital inputs received by said at least one DAC.

8. The system of claim 7, further comprising a gray scale conversion logic coupled to said gray scale current pulse look-up table.

9. The system of claim 8, wherein said gray scale conversion logic is adapted to receive video information and generate said pixel gray scales for said gray scale conversion logic.

10. The system of claim 1, further comprising a pulse-width time control circuit for controlling the pulse-widths of said current source pulses.

11. The system of claim 10, wherein said pulse-width time control circuit is coupled to a gray scale current pulse look-up table.

12. The system of claim 10, wherein said pulse-width time control circuit is synchronized with a column clock.

13. The system of claim 12, further comprising a phase-locked-loop (PLL) coupled between the column clock and a clock input to said pulse-width time control circuit, wherein said PLL is adapted to synchronize said clock input with said column clock.

14. The system of claim 13, wherein said PLL generates said clock input to said pulse-width time control circuit.

15. The system of claim 1, further comprising an analog-to-digital converter (ADC) for converting said voltages on said columns to digital voltage values.

16. The system of claim 15, further comprising a digital comparator for comparing said voltages representing said pixel gray scales with said digital voltage values from said ADC.

17. The system of claim 16, wherein comparisons of said voltages representing said pixel gray scales with said digital voltage values are used in determining compensation coefficients for each of said plurality of columns having different capacitance values.

18. The system of claim 17, further comprising a memory for storing said compensation coefficients.

19. The system of claim 1, wherein each of said plurality of columns has substantially the same capacitance.

20. The system of claim 1, wherein each of said plurality of columns is compensated to have substantially the same capacitance.

21. The system of claim 20, further comprising at least one capacitor connected to some ones of said plurality of columns such that each of said plurality of columns has substantially the same capacitance as another column.

22. The system of claim 21, further comprising a column capacitance compensation circuit and at least one switch for coupling said at least one capacitor to said some ones of said plurality of columns.

23. The system of claim 22, further comprising a column capacitance compensation memory coupled to said column capacitance compensation circuit, said column capacitance compensation memory storing connection setting for said at least one switch for coupling said at least one capacitor to said some ones of said plurality of columns.

24. The system of claim 21, wherein said at least one capacitor is a plurality of capacitors having capacitance values in a binary progression.

25. The system of claim 1, wherein said LCD is fabricated on a semiconductor integrated circuit.

26. The system of claim 25, wherein said at least one DAC is fabricated on said semiconductor integrated circuit.

27. The system of claim 3, wherein said plurality of column switches and said plurality of row switches are fabricated on a semiconductor integrated circuit.

28. The system of claim 4, wherein said column control logic and said row control logic are fabricated on a semiconductor integrated circuit.

29. The system of claim 5, wherein said LCD pixel matrix address controller is fabricated on a semiconductor integrated circuit.

30. The system of claim 6, wherein said video frame to LCD pixel matrix address logic is fabricated on a semiconductor integrated circuit.

31. The system of claim 7, wherein said gray scale current pulse look-up table is fabricated on a semiconductor integrated circuit.

32. The system of claim 8, wherein said gray scale conversion logic is fabricated on a semiconductor integrated circuit.

33. The system of claim 10, wherein said pulse-width time control circuit is fabricated on a semiconductor integrated circuit.

34. The system of claim 11, wherein said gray scale current pulse look-up table is fabricated on a semiconductor integrated circuit.

35. The system of claim 16, wherein said comparator and said ADC are fabricated on a semiconductor integrated circuit.

36. The system of claim 22, wherein said column capacitance compensation circuit and said at least one switch are fabricated on a semiconductor integrated circuit.

37. A current controlled charging circuit adapted for charging columns of a liquid crystal display having a matrix of liquid crystal pixels, said current controlled charging circuit comprising:
at least one digital-to-analog converter (DAC) adapted to receive digital inputs representative of pixel gray scales, said at least one DAC having an output adapted for charging each of a plurality of columns of a liquid crystal display (LCD) to voltages representing said pixel gray scales, wherein the output comprises current source pulses having amplitudes and pulse-widths that charge each of said plurality of columns to said voltages.

38. The current controlled charging circuit of claim 37, further comprising a gray scale current pulse look-up table adapted for converting said pixel gray scales into the digital inputs received by said at least one DAC.

39. The current controlled charging circuit of claim 38, further comprising a gray scale conversion logic coupled to said gray scale current pulse look-up table.

40. The current controlled charging circuit of claim 39, wherein said gray scale conversion logic is adapted to receive video information and generate said pixel gray scales for said gray scale conversion logic.

41. The current controlled charging circuit of claim 37, further comprising a pulse-width time control circuit for controlling the pulse-widths of said current source pulses.

42. The current controlled charging circuit of claim 41, wherein said pulse-width time control circuit is coupled to a gray scale current pulse look-up table.

43. The current controlled charging circuit of claim 41, wherein said pulse-width time control circuit is synchronized with a column clock.

44. The current controlled charging circuit of claim 43, further comprising a phase-locked-loop (PLL) coupled between the column clock and a clock input to said pulse-width time control circuit, wherein said PLL is adapted to synchronize said clock input with said column clock.

45. The current controlled charging circuit of claim 44, wherein said PLL generates said clock input to said pulse-width time control circuit.

46. The current controlled charging circuit of claim 37, further comprising a comparator circuit for comparing said voltages representing said pixel gray scales with said voltages from said ADC.

47. The current controlled charging circuit of claim 46, wherein comparisons of said voltages representing said pixel gray scales with said voltage are used in determining compensation coefficients for each of said plurality of columns having different capacitance values.

48. The current controlled charging circuit of claim 47, further comprising a memory for storing said compensation coefficients.

49. A method using a current controlled charging circuit for charging columns of a liquid crystal display, said method comprising the steps of:
providing a liquid crystal display (LCD) having a matrix of liquid crystal pixels, said matrix comprising a plurality of columns and a plurality of rows, wherein an intersection of a row and a column defines a location of a pixel; and
charging with a current controlled charging circuit each of said plurality of columns to voltages representing pixel gray scales.

50. The method of claim 49, wherein the current controlled charging circuit is a current output digital-to-analog converter (DAC).

51. The method of claim 49, further comprising the step of selectively coupling said matrix of pixels to said plurality of columns.

52. The method of claim 49, wherein the step of charging is done with current pulses.

53. The method of claim 52, further comprising the step of controlling amplitudes of said current pulses.

54. The method of claim 52, further comprising the step of controlling pulse-widths of said current pulses.

55. The method of claim 54, wherein the pulse-widths are determined with a gray scale current pulse look-up table.

56. The method of claim 49, further comprising the step of measuring the voltages on said plurality of columns.

57. The method of claim 56, further comprising the step of comparing the voltages representing the pixel gray scales with the voltages measured on said plurality of columns.

58. The method of claim 57, further comprising the step of determining compensation coefficients from differences between the voltages representing the pixel gray scales and the voltages measured on said plurality of columns for each of said plurality of columns.

59. The method of claim 58, further comprising the step of storing the compensation coefficients in a memory.

60. The method of claim 49, further comprising the step of adding compensating capacitance to said plurality of columns such that each of said plurality of columns has substantially the same capacitance as the others.

61. The system of claim 1, further comprising a circuit for setting said plurality of columns to a desired voltage before charging said plurality of columns to said voltages.

62. The system of claim 61, wherein the desired voltage is substantially zero.

63. The system of claim 1, further comprising a circuit for discharging said plurality of columns before charging said plurality of columns to said voltages.

64. The system of claim 1, further comprising a comparison circuit for comparing said voltages representing said pixel gray scales with said voltages on said columns, said comparison circuit output being used in determining compensation coefficients for each of said plurality of columns having different capacitance values.

65. The system of claim 20, wherein each of said plurality of columns is compensated with a fuse link connected plurality of capacitors.

66. The method of claim 60, wherein the step of adding compensating capacitance to said plurality of columns comprises the steps of blowing fuse links connected to a plurality of compensation capacitors.
